(19) United States
(12) Patent Application Publication
(10) Pub. No.: US 2015/0100920 A1
(43) Pub. Date: Apr. 9, 2015

(54) COMPANION CONTENT PRESENTED ALONG WITH INVITATIONAL CONTENT ITEM

(71) Applicant: Apple Inc., Cupertino, CA (US)

(72) Inventors: Mehul K. Sanghavi, Sunnyvale, CA (US); Michael Froimowitz Greenzeiger, Sunnyvale, CA (US); Ravindra Phulari, San Jose, CA (US)

(73) Assignee: Apple Inc., Cupertino, CA (US)

(21) Appl. No.: 14/045,688

(22) Filed: Oct. 3, 2013

(51) Int. Cl. G06F 3/0482; G06F 3/0487; G06F 3/0484

(52) U.S. Cl. CPC G06F 3/0482; G06F 3/04842; G06F 3/0487
USPC 715/804

(57) ABSTRACT

Disclosed are systems, methods, and non-transitory computer-readable storage media for presenting companion content along with invitational content. The companion content can present the user with a listing of alternate invitational content items that, upon selection, can be presented in place of the invitational content item being presented. The companion content provides the user with an opportunity to modify the invitational content item presented to the user, as well as enables an interested user to view as many invitational content items as desired. For example, in some embodiments, a user can extend the invitational content presented by selecting alternate invitational content items to view. If a user selection to view an alternate invitational content item is not received within a predetermined period of time, the invitational content can end and any paused primary content can be resumed.

### TECHNICAL FIELD

The present technology pertains to invitational content, and more specifically pertains to companion content that enables a user to modify the invitational content.

### BACKGROUND

Invitational content items, such as advertisements, are often presented along with primary content. For example, a user may be presented with one or more advertisements while watching an online video or playing a game. Often the advertisements are enabled to allow a user to navigate to secondary content regarding an advertised product or service, however this requires a user to navigate away from the primary content. Further, the user generally has little control over the advertisements presented. While some advertisements can be targeted based on a user profile or the primary content, the user cannot select a different advertisement during playback. This can result in a user being presented with an advertisement that is of no interest to the user. Alternatively, if the user is interested in the advertised product, the user has no way of requesting to view an additional advertisement for the same advertised product or service. Accordingly, improvements are necessary.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for presenting companion content along with invitational content; the companion content can be used to modify the invitational content. For example the companion content can present the user with a listing of alternate invitational content items that the user can select to view. Upon selection of one of the listed alternate invitational content item, the selected invitational content item can be presented in place of the invitational content item being presented. In some embodiments, the selected invitational content can be presented immediately upon selection. Alternatively, in some embodiments, the selected invitational content item can be presented upon completion of the presented invitational content item.

The companion content provides the user with an opportunity to modify the invitational content item presented to the user, as well as enables an interested user to view as many invitational content items as desired. For example, in some embodiments, a user can extend the invitational content presented by selecting alternate invitational content items to view. If a user selection to view an alternate invitational content item is not received within a predetermined period of time, the invitational content can end and any paused primary content can be resumed.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network in accordance with the invention;

FIG. 2 illustrates an exemplary embodiment of companion content presented along with invitational content;

FIG. 3 illustrates an exemplary embodiment of companion content;

FIG. 4 illustrates an exemplary method of presenting alternate invitational content items to a user; and

FIGS. 5A and 5B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for presenting companion content along with invitational content; the companion content can be used to modify the invitational content. For example the companion content can present the user with a listing of alternate invitational content items that the user can select to view. Upon selection of one of the listed alternate invitational content items, the selected invitational content item can be presented in place of the invitational content item being presented. In some embodiments, the selected invitational content can be presented immediately upon selection. Alternatively, in some embodiments, the selected invitational content item can be presented upon completion of the invitational content item being presented.

The companion content provides the user with an opportunity to modify the invitational content item presented to the user, as well as enables an interested user to view as many invitational content items as desired. For example, in some embodiments, a user can extend the invitational content presented by selecting alternate invitational content items to view. If a user selection to view an alternate invitational content item is not received within a predetermined period of time, the invitational content can end and any paused primary content can be resumed.

This can be advantageous to invitational content providers because a user can select to view the invitational content items that interest the user, and thus the invitational content provider is less likely to be charged for presentation of an invitational content item to an uninterested user.

Further, in some embodiments, the presentation of the invitational content can be provided for a flat charge to an invitational content provider, even if a user extends the invitational content by selecting to view multiple invitational content items. This can result in reducing the cost to the invitational content provider while maximizing the value they receive.

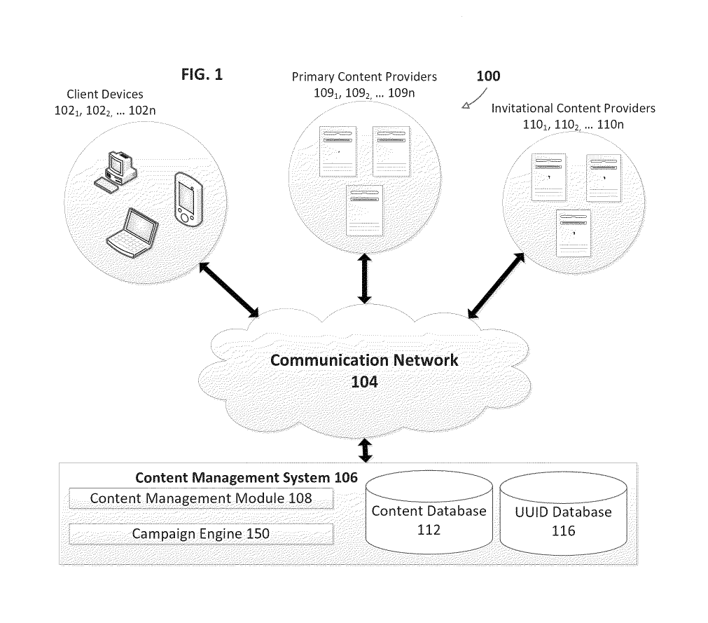

FIG. 1 illustrates an exemplary system configuration 100, wherein electronic devices communicate via a network for purposes of exchanging content and other data. As illustrated, multiple computing devices can be connected to communication network 104 and be configured to communicate with each other through use of communication network 104. Communication network 104 can be any type of network, including a local area network (“LAN”), such as an intranet, a wide area network (“WAN”), such as the internet, or any combination thereof. Further, communication network 104 can be a public network, a private network, or a combination thereof. Communication network 104 can also be implemented using any number of communications links associated with one or more service providers, including one or more wired communication links, one or more wireless communication links, or any combination thereof. Additionally, communication network 104 can be configured to support the transmission of data formatted using any number of protocols.

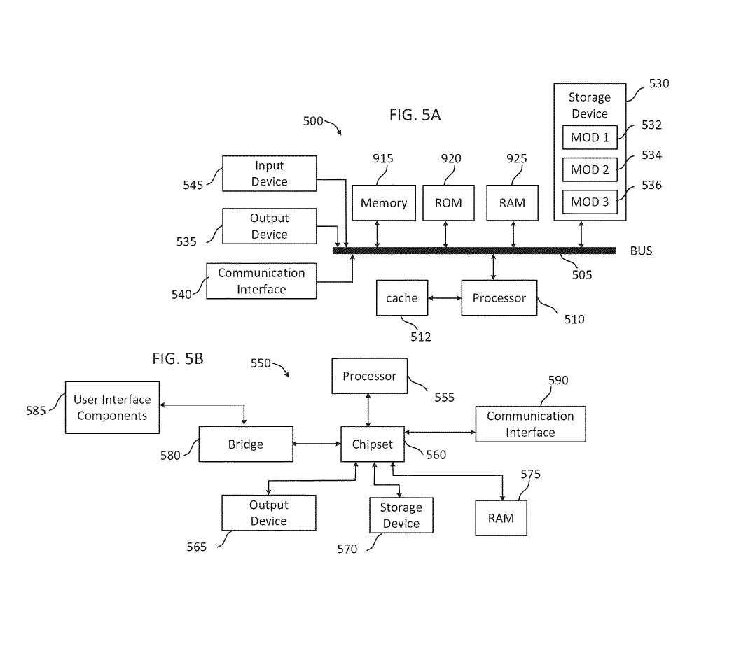

Multiple computing devices can be connected to communication network 104. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 500 of FIGS. 5A and 5B. To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

In system 100, invitational content is delivered to client devices 102₁ . . . 102ₙ (collectively “102”) connected to communication network 104 by direct and/or indirect communications with content management system 106. In particular, content management system 106 receives a request for a content package of electronic-invitational content, such as a web page, an application, a game, or media, etc., from one of client devices 102. In the various embodiments, one or more types of invitational content can be combined in a content package. Client devices 102 can be configured to render the received invitational content. This can include display or playing the invitational content appropriately depending on the form of the invitational content. For example, the invitational content can include text, graphics, audio, video, executable code or any combination thereof.

Upon successfully rendering the delivered invitational content, client devices 102 can be configured to send a notification to the content management system 106. In some embodiments the notification can be a web beacon such as an embedded tracking pixel. In some embodiments the operating system of the client devices 102 can be configured to report rendering of the invitational content. In some embodiments, the notification can be cryptographically secured by means such as authentication and digests.

In some embodiments, the invitational content can be associated with a product or can directly or indirectly advertise a product. In some embodiments, the content package can be configured to replace or update invitational content in a content package already delivered to the user terminal.

Further, the invitational content can be active invitational content. That is, invitational content that is designed to primarily elicit a pre-defined response from the user. For example, active invitational content can include one or more types of advertisements configured to be clicked upon, solicit information, or be converted by the user into a further action, such as a purchase or download of the advertised item. In some embodiments, active invitational content can include secondary views that can be presented to a user upon selection of an initial view of the invitational content. For example, the initial view can be a banner advertisement that, when selected, directs the user to a secondary view such as a multimedia advertisement.

However, invitational content can also include passive invitational content. That is, invitational content that is designed to primarily inform the user. In some cases, passive invitational content can include information that can lead or direct users to active invitational content. Additionally, the invitational content can be dynamic invitational content. That is, invitational content that varies over time or that varies based on user interaction with the invitational content. However, the various embodiments are not limited in this regard and the invitational content can be static invitational content that does not vary over time or that varies based on user interaction. In the various embodiments, an invitational content in a content package can be static or dynamic and active or passive. Further, various types of invitational content can be combined in a same content package.

After receiving the request for invitational content, content management system 106 selects the invitational content in response to the request and transmits the assembled invitational content to the requesting one of client devices 102. In some embodiments, content management system 106 has preselected the invitational content before the request is received. Thereafter, content management system 106 assembles a content package of invitational content and causes the content package to be delivered to the requesting one of client devices 102.

Content management system 106 can include content management module 108 that facilitates generation of the assembled content package, which can include invitational content. Specifically, content management module 108 can combine content from one or more primary content providers 109₁ . . . 109ₙ (collectively “109”) and content from one or more invitational content providers 110₁ . . . 110ₙ (collectively “110”) to generate the assembled content package for client devices 102. For example, in the case of a web page being delivered to a requesting one of client devices 102, content management module 108 can assemble a content package by requesting the data for the web page from one of primary content providers 109 maintaining the web page. For the invitational content on the web page provided by invitational content providers 110, content management module 108 can request the appropriate data according to the arrangement between primary and invitational content providers 109 and 110. In some embodiments, client devices 102 can directly request or already have access to primary content from primary content provider 109. In such embodiments, client devices 102 can further request invitational content from content management system 106. Content management system 106 can identify and deliver invitational content appropriate for association with primary content. For example, primary content, such as an application, can already reside or be running on one of client devices 102, and the primary content can direct the client device 102 to request invitational content from content management system 106 to be associated with primary content on the client device 102.

Although primary and invitational content providers 109 and 110 are presented herein as separate entities, this is for illustrative purposes only. In some cases, primary and invitational content providers 109 and 110 can be the same entity. Thus, a single entity can define and provide both the primary and the invitational content.

Although content management module 108 can be configured to request that content be sent directly from primary and invitational content providers 109 and 110, a cached arrangement can also be used to improve performance of content management system 106 and improve overall user experience. That is, content management system 106 can include content database 112 for locally storing/caching content maintained by primary and invitational content providers 109 and 110. The data in content database 112 can be refreshed or updated on a regular basis to ensure that the content in content database 112 is up-to-date at the time of a request from one of client devices 102. However, in some cases, content management module 108 can be configured to retrieve content directly from primary content provider 109 and invitational content provider 110 if the metadata associated with the data in content database 112 appears to be outdated or corrupted.

In some embodiments, the primary and invitational content can be assembled by client devices 102. For example, the primary content and invitational content can be delivered to one of client devices 102 and assembled at client device 102 based on assembly rules dictating how to properly assemble the primary and invitational content together. In some embodiment, the assembly rules can be delivered to client devices 102 by content management system 106.

In the various embodiments, content management system 106 can also include unique user identifier (UUID) database 116 that can be used for managing sessions with the various client devices 102. UUID database 116 can be used with a variety of session management techniques. For example, content management system 106 can implement an HTTP cookie or any other conventional session management method (e.g., IP address tracking, URL query strings, hidden form fields, window name tracking, authentication methods, and local shared objects) for client devices 102 connected to content management system 106 via a substantially persistent network session. However, other methods can be used as well. For example, in the case of handheld communications devices, such as mobile phones, smart phones, tablets, or other types of client devices connecting using multiple or non-persistent network sessions, multiple requests for content from such devices may be assigned to a same entry in UUID database 116. Content management system 106 can analyze the attributes of requesting client devices 102 to determine whether such requests can be attributed to the same user. Such attributes can include device or group-specific attributes.

Content management system 106 can include campaign engine 150, which can be configured to fulfill campaigns for content providers by managing inventory and pricing of invitational content items delivered to client devices 102. Content providers can arrange to have their invitational content delivered by content management system 106 based on a pricing scheme. For example, the pricing scheme can be arranged so that a content provider is charged a set price for each time an invitational content item is presented. Alternatively or additionally, a content item can be charged each time an invitational content item is selected.

A user selecting an invitational content item can include clicking an invitational content item presented on a client device through use of an input provided by the client device. For example, a user selecting an invitational content item can include a user clicking the invitational content item using a touchscreen of the client device displaying the invitational content item. Alternatively, a user selecting an invitational content item can include a user clicking the invitational content item using a mouse of the client device displaying the invitational content item.

Campaign engine 150 can be configured to record each time an invitational content item is presented and each selection received by an invitational content item, which can be used to calculate a cost accrued by the content provider for delivery of the invitational content items.

A content provider can arrange a campaign in any number of ways. In some embodiments, a content provider can choose a maximum spend limit for a period of time. For example a campaign can be configured so that the cost of delivering the invitational content does not exceed $10,000 over a month. In some embodiments the campaign can be configured to have a spend limit over a large time interval as well as another spend limit for a smaller time interval. For example, a campaign can be allocated to not exceed $10,000 over a month, but further not to exceed $500 in any given day. Campaigns can also be configured to have a minimum amount to be spent per specified time interval. For example, a campaign can have a daily max spend of $1,000 per day as well as a minimum spend of $950 per day. These examples are not meant to be limiting, campaigns can be configured in any number of ways known in the art.

Campaign engine 150 can be arranged to manage the delivery of the invitational content based on the parameters of the campaign. For example, if a content provider has arranged a maximum spend limit of $1,000 per day, campaign engine 150 can monitor the number of selections received by the invitational content item, and upon the spend limit of $1,000 being reached, no longer deliver the item of invitational content associated with the campaign. Rather, campaign engine 150 can select other invitational content items to deliver to a requesting one of client devices 102.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

While content management system 106 is presented with specific components, it should be understood by one skilled in the art, that the architectural configuration of system 106 is simply one possible configuration and that other configurations with more or less components are also possible. For example, in some embodiments, content management system 106 can be configured to provide companion content that is presented along with an invitational content item. The companion content can be configured to enable a user to modify the invitational content. For example, the companion content can list alternate invitational content items that can be selected by a user. A selected alternate invitational content item can be presented in place of the invitational content item being performed, either immediately or after conclusion of the invitational content item being presented.

The companion content can be configured to request a selected alternate invitational content item upon receiving an input selecting the alternate invitational content item. This can include transmitting a request to content management system 106 to return the requested invitational content item. Alternatively, the requested alternate invitational content item can be accessed from a local cache on a client device.

In some embodiments, the invitational content item presented can be extended when an alternate invitational content item is selected. For example, a user may be required to view at least one invitational content item when viewing primary content, but the user may extend the number of invitational content items that are presented by selecting alternate invitational content items. Thus, a user watching an online video may be require to watch one video advertisement before returning to the video, but the user can extend that period by selecting to view alternate advertisements if desired. A user may therefore watch more than the minimum required number of advertisements.

This can be beneficial to invitational content providers that would like to present as many of their invitational content items to users as possible. Further, in some embodiments, campaign engine 150 can be configured to count the invitation content presented to the user as a single view or selection, even if the user selects to extend the invitational content item by selecting to view multiple alternate invitational content items. This further benefits invitational content providers by maximizing their campaign budget.

In some embodiments, the companion content can be presented in a portion of the screen that is unused by the invitational content and/or primary content. For example, the companion content can be presented in a portion of the display that is generally blacked out due to a difference in aspect ratio between the invitational content and the display, often referred to letterboxing.

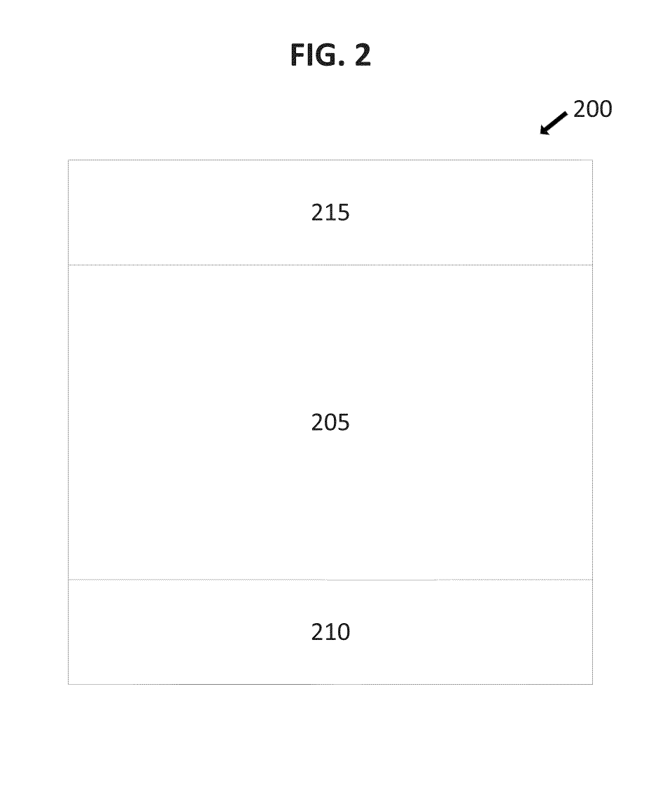

FIG. 2 illustrates an exemplary embodiment of companion content presented along with invitational content. As shown screen 200 is broken into 3 segments: primary segment 205 and secondary segments 210 and 215. Primary content, such as video, games, etc. can be presented in primary segment 205. Secondary segments 210 and 215 can be blacked out due to a difference in aspect ratio between screen 200 and the primary content presented in primary segment 205. This technique is commonly referred to as letterboxing. While letterboxing provides for the primary content to be presented in an aspect ratio that differs from the primary content, secondary segments 210 and 215 are left unused.

In some embodiments, invitational content can be presented in secondary segment 210 and/or 215. For example, invitational content items such as banner advertisements can be presented above and/or below primary content presented in primary segment 205.

In some embodiments, invitational content can be presented in primary segment 205. For example, invitational content, such as an advertisement, can be scheduled to be presented during the primary content at schedule playback points or at predetermined time intervals. Alternatively, invitational content can be presented in primary segment 205 as a result of a user selecting an invitational content item presented in secondary segment 210 or 215. For example, the user can click on a banner advertisement presented in secondary segments 210 or 214 to view a video advertisement presented in primary segment 205. The primary content presented in primary segment 205 can be paused to allow for the invitational content to be presented in primary segment 205.

In some embodiments, companion content can be presented in secondary segments 210 and/or 215 while invitational content is presented in primary segment 205. Companion content can be content related to the presented invitational content. For example, the companion content can be provided by the same invitational content provider as the invitational content presented in primary segment 205. For example, the companion content can be a banner advertisement advertising the same product or service as the invitational content presented in primary segment 205.

In some embodiments, the companion content can include functionality that enables a user to modify the invitational content item presented in primary segment 205. For example, the companion content can list alternate invitational content items that can be viewed. A user can select on an alternate invitational content item to view the alternate invitational content item. Upon selection, the alternate invitational content item can be presented in primary segment 205.

In some embodiments, the invitational content item presented in primary segment 205 can be stopped prior to conclusion so that the selected alternate invitational content item can be presented. Alternatively, the alternate invitational content item can be presented after the invitational content item presented in primary segment 205 has concluded. In this type of embodiment, the user can queue multiple alternate invitational content items to view and each will be presented after the conclusion of the previously queued invitational content item.

If a user does not select to view an alternate invitational content items, or if alternate invitational content items selected have all been presented without a user selecting any further alternate invitational content items to view, the primary content can be resumed in primary segment 205.

Presenting companion content along with invitational content enables invitational content providers to provide multiple invitational content items to a user, which the user can select to view if desired. For example, the alternate invitational content items presented can each be a segment in a continuous story and the user can select to view as many segments as desired. Alternatively, the alternate invitational content items can each relate to a different product offered by an advertiser and the user can select to learn more about the products that interest the user.

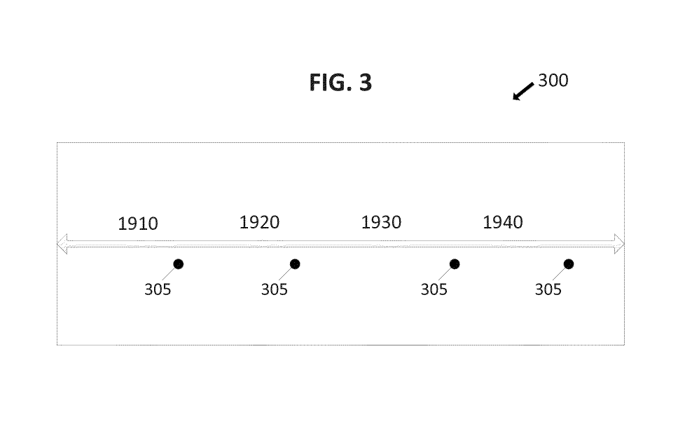

FIG. 3 illustrates an exemplary embodiment of companion content. As shown, companion content 300 includes a timeline with various selection points 305. Each selection point can represent an invitational content item related to the point along the timeline. In some embodiments, a user can select a selection point to view the invitational content related to the point along the time line. For example, if the user selects the selection point near 1930, the user will be presented with an invitational content item relating to that period of time, such as a history of a company during the 1930s.

Alternatively, in some embodiments, the companion content can be configured such that a user can scroll along the time line, which causes the presented invitational content to change. For example, the invitational content item related to the selection point that is most center can be presented on the display as a user scrolls along the time line.

In some embodiments, the user can scroll by swiping the time lint in a direction. Alternatively, in some embodiments, the time line can be configured to scroll in response movement detected by the client device presenting the companion content. For example, the client device can include a motion detection sensor such as a gyroscope and the time line can be configured to scroll in response to the client device tilting in specified directions.

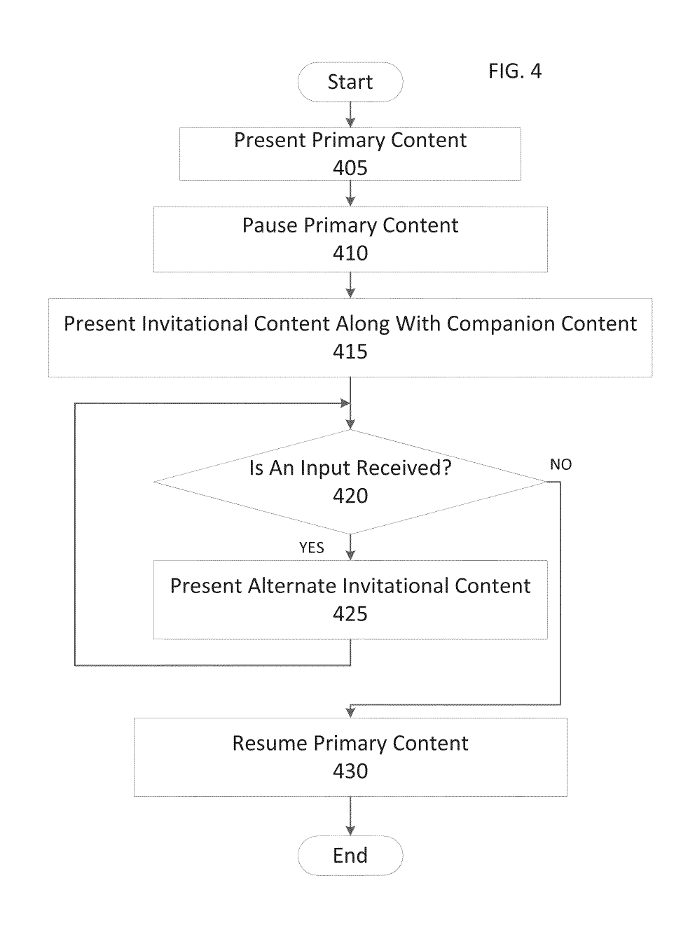

FIG. 4 illustrates an exemplary method of presenting alternate invitational content items to a user. As shown, the method begins at block 405 where primary content is presented to a user. At block 410 the primary content is paused and at block 415 an invitational content item and companion content are presented to the user.

In some embodiments, the invitational content item can be presented to the user in a primary segment of the screen and the companion content can be presented to the user in a secondary segment of the screen.

At block 420 it is determined whether an input identifying an alternate invitational content item is received prior to a predetermined amount of time expiring. For example, the predetermined time can be the length of the invitational content item being presented.

If at block 420 an input is received, the method continues to 425 where the alternate invitational content item is presented and the method returns to block 420. In some embodiments, the alternate invitational content item can be presented in the primary segment of the screen.

Alternatively, if at block 420 an input is not received, then the method continues to block 430 where the primary content is resumed after the invitational content item concludes. The method then ends.

FIG. 5A, and FIG. 5B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 5A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
presenting, by a processor, primary content in a primary segment of a display;
pausing, by the processor, the primary content;
presenting, by the processor:
a first invitational content item in the primary segment of the display, and
a companion content item in a secondary segment of the display, the companion content item including a first selectable portion;
receiving, by the processor, a first input within a predetermined time period after presenting the first invitational content item, the first input indicating selection of the first selectable portion of the companion content item; and
presenting, by the processor, a second invitational content item in the primary segment of the display.

2. The method of claim 1, further comprising:
after a predetermined amount of time after presenting the second invitational content item has elapsed without receiving a second input, resuming the primary content in the primary segment of the display.

3. The method of claim 1, wherein the companion content item includes a second selectable portion, the method further comprising:
receiving a second input within a predetermined time period after presenting the second invitational content item, the second input indicating selection of the second selectable portion of the companion content item; and
presenting a third invitational content item in the primary segment of the display.

4. The method of claim 1, wherein the primary content is presented in a different aspect ratio than an aspect ratio of the display, and the secondary segment of the display is a portion of the display that is unused by the different aspect ratio.

5. The method of claim 1, wherein presentation of the first invitational content item results in a monetary charge to an invitational content provider, and presentation of the second invitational content item does not result in a charge to the invitational content provider.

6. The method of claim 1, wherein the second invitational content item is presented after the first invitational content item concludes.

7. The method of claim 1, wherein the companion content item presents the first selectable portion at a first point on a timeline and the second invitational content item is related to the point on the timeline.

8. A system comprising:
a processor; and
a memory containing instructions that, when executed, cause the processor to:
present primary content in a primary segment of a display;
pause the primary content;
present a first invitational content item in the primary segment of the display, and a companion content item in a secondary segment of the display, the companion content item including a first selectable portion;
receive a first input within a predetermined time period after presenting the first invitational content item, the first input indicating selection of the first selectable portion of the companion content item; and
present a second invitational content item in the primary segment of the display.

9. The system of claim 8, wherein the instructions further cause the processor to:
after a predetermined amount of time after presenting the second invitational content item has elapsed without receiving a second input, resume the primary content in the primary segment of the display.

10. The system of claim 8, wherein the companion content item includes a second selectable portion, and the instructions further cause the processor to:
receive a second input within a predetermined time period after presenting the second invitational content item, the second input indicating selection of the second selectable portion of the companion content item; and
present a third invitational content item in the primary segment of the display.

11. The system of claim 8, wherein the primary content is presented in a different aspect ratio than an aspect ratio of the display, and the secondary segment of the display is a portion of the display that is unused by the different aspect ratio.

12. The system of claim 8, wherein presentation of the first invitational content item results in a monetary charge to an invitational content provider, and presentation of the second invitational content item does not result in a charge to the invitational content provider.

13. The system of claim 8, wherein the second invitational content item is presented after the first invitational content item concludes.

14. The system of claim 8, wherein the companion content item presents the first selectable portion at a first point on a timeline and the second invitational content item is related to the point on the timeline.

15. A non-transitory computer-readable medium containing instructions that, when executed by a computing device, cause the computing device to:
present primary content in a primary segment of a display;
pause the primary content;
present a first invitational content item in the primary segment of the display, and a companion content item in a secondary segment of the display, the companion content item including a first selectable portion;
receive a first input within a predetermined time period after presenting the first invitational content item, the first input indicating selection of the first selectable portion of the companion content item; and
present a second invitational content item in the primary segment of the display.

16. The non-transitory computer-readable medium of claim 15, wherein the instructions further cause the computing device to:
after a predetermined amount of time after presenting the second invitational content item has elapsed without receiving a second input, resume the primary content in the primary segment of the display.

17. The non-transitory computer-readable medium of claim 15, wherein the companion content item includes a second selectable portion, the instructions further causing the processor to:
receive a second input within a predetermined time period after presenting the second invitational content item, the second input indicating selection of the second selectable portion of the companion content item; and
present a third invitational content item in the primary segment of the display.

18. The non-transitory computer-readable medium of claim 15, wherein the primary content is presented in a different aspect ratio than an aspect ratio of the display, and the secondary segment of the display is a portion of the display that is unused by the different aspect ratio.

19. The non-transitory computer-readable medium of claim 15, wherein presentation of the first invitational content item results in a monetary charge to an invitational content provider, and presentation of the second invitational content item does not result in a charge to the invitational content provider.

20. The non-transitory computer-readable medium of claim 15, wherein the second invitational content item is presented after the first invitational content item concludes.
